(19) United States
(12) Patent Application Publication
(10) Pub. No.: US 2013/0132221 A1
(43) Pub. Date: May 23, 2013

(54) SOCIAL SHOPPPING ON A NETWORKED PUBLICATION SYSTEM

(71) Applicants: Donald Bradford, Acampo, CA (US); Allison Chapas, San Francisco, CA (US); Avinash Gangadharan, Fremont, CA (US); Brandon Lai, Morgan Hill, CA (US); Angela K. Lau, San Jose, CA (US); Karlyn Neel, Oakland, CA (US); Nisha Victor, San Jose, CA (US); Rebecca Wenzlau, Palo Alto, CA (US)

(72) Inventors: Donald Bradford, Acampo, CA (US); Allison Chapas, San Francisco, CA (US); Avinash Gangadharan, Fremont, CA (US); Brandon Lai, Morgan Hill, CA (US); Angela K. Lau, San Jose, CA (US); Karlyn Neel, Oakland, CA (US); Nisha Victor, San Jose, CA (US); Rebecca Wenzlau, Palo Alto, CA (US)

(21) Appl. No.: 13/341,978

(22) Filed: Dec. 31, 2011

Related U.S. Application Data
(60) Provisional application No. 61/561,083, filed on Nov. 17, 2011.

(51) Int. Cl. G06Q 30/06; G06Q 99/00

(52) U.S. Cl. 705/26.1; 705/319

(57) ABSTRACT

Receiving from a user of a publication system first content and a request to create a poll for the first content, the poll for receiving poll commentary about the first content from participants in a social network. Transmitting the first content and the request to create a poll to the social network. Receiving from the social network poll commentary about the first content. Receiving from the social network additional content for use in the poll. Receiving second content and a request for poll commentary about the second content from the user and, responsive to receiving the second content and the request for poll commentary, transmitting to the social network a request for poll commentary for the first content and the second content.

### RELATED APPLICATIONS

This present application claims the priority benefits of U.S. Provisional Application No. 61/561,083 filed on Nov. 17, 2011, which is incorporated herein by reference.

### BACKGROUND

Applications available on the Internet have progressed from facilitating a medium of information delivery to a venue for sales and, more recently, to a platform for social networking. An online marketplace such as eBay.com® is an example of an online seller. Similarly, Facebook.com® and twitter.com® are examples of social networking.

### TECHNICAL FIELD

The subject matter disclosed herein generally relates to the processing of data. Specifically, the present disclosure addresses systems and methods of providing content generated by a user of a networked publication system for transmission to a social network platform.

### BRIEF DESCRIPTION OF THE DRAWINGS

Some embodiments are illustrated by way of example and not limitation in the figures of the accompanying drawings in which:

FIG. 1 is a network diagram depicting a system, according to one example embodiment, having a client-server architecture;

FIG. 2 is a block diagram illustrating social applications, according to an embodiment;

FIG. 3A is a block diagram illustrating a database, according to an embodiment;

FIG. 3B is an illustration of a system usable with or as part of the system of FIG. 1;

FIG. 4 is a screen shot illustrating one operation of an application useful in an embodiment;

FIG. 5 is a screen shot illustrating a default tray useful in an embodiment;

FIG. 6 is screen shot illustrating one use of the default tray of FIG. 5 useful in an embodiment;

FIG. 7 is a screen shot illustrating an expansion of the default tray of FIGS. 5 and 6;

FIG. 8 is a screen shot illustrating a browsing function useful in an embodiment;

FIG. 9 is a screen shot illustrating a social network communication useful in an embodiment;

FIG. 10 is a screen shot illustrating another social network communication useful in an embodiment;

FIG. 11 is a screen shot illustrating an additional social network communication useful in an embodiment;

FIG. 12 is a screen shot illustrating a status, results and chat operation useful in an embodiment;

FIG. 13 is an illustration of a photograph useful in one embodiment;

FIG. 14 is an illustration of one operation using the photograph of FIG. 13;

FIG. 15 is an illustration of an example of a landing page using a photograph tagging function useful in an embodiment;

FIG. 16 is an illustration of another example of a landing page using a photograph tagging function useful in an embodiment;

FIG. 17 illustrates a participant's view of a page useful in an embodiment;

FIG. 18 illustrates an organizer's view of a page useful in an embodiment;

FIG. 19 illustrates the operation of a page useful for a chatting and purchasing using a social network platform useful in an embodiment;

FIGS. 20A-20D are representations of flowcharts depicting operations of an embodiment; and

FIG. 21 is a block diagram illustrating components of a machine, according to some example embodiments, able to read instructions from a machine-readable medium and perform any one or more of the methodologies discussed herein.

In the figures, the same or similar references have been used to indicate the same or similar features unless otherwise indicated.

### DETAILED DESCRIPTION

In the following description, for purposes of explanation, numerous specific details are set forth in order to provide embodiments of the subject matter set forth in the present disclosure. It will be evident, however, to one skilled in the art that the present disclosure may be practiced without these specific details.

Content may be provided over a network from a first server to a second server. The first server may be, e.g., a web server, a database server, or a listing server. For example, a network-based publication system may include a first web server that provides content over a network to the second web server. Specifically, the second server may be a third-party social network server that provides a social networking service (e.g., Facebook®) to millions of users and provides social network data. Herein, the use of “Facebook” could as easily be Twitter® or any other social network service.

Each of the first server and second server may provide the content to one or more client machines, which client machines may be the same client machine or a different client machine.

A client machine may be a computer, a mobile device, or other machine functioning, temporarily or permanently, as a client in relation to the content machine. For example, the client machine may, as indicated above, have a user. The user may be a human user or a machine-implemented user (e.g., software executing on the client machine). The content provided by the social network server may be presented to a client machine and thence to the user by the client machine. Other couplings between these or similar servers and one or more client machines may be used.

### Platform Architecture

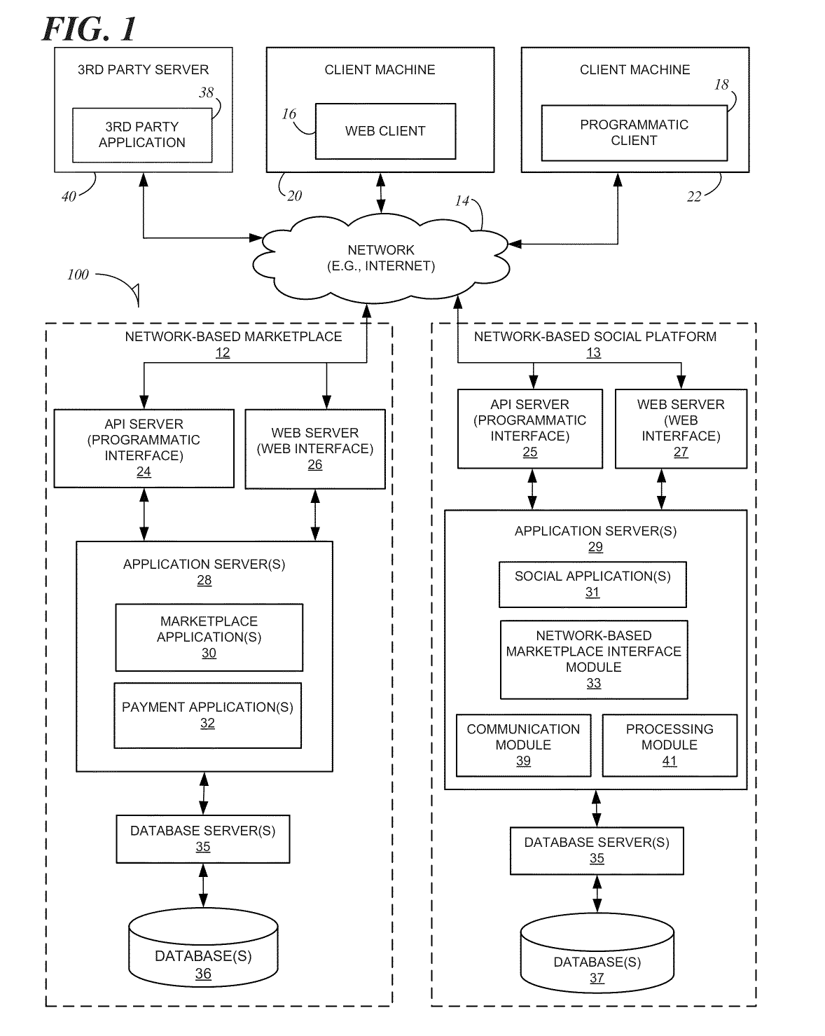

FIG. 1 is a network diagram depicting a system 100, according to one embodiment of the present disclosure, having a client-server and a peer-to peer architecture. The system 10 facilitates shopping activity, in the exemplary form of a network-based marketplace 12 and a network-based social platform 13 that communicate over a network 14. In one embodiment, the network-based marketplace 12 and the network-based social platform 13 communicate in peer-to peer architecture via programmatic interfaces. Further, the network-based marketplace 12 and the network-based social platform 13 respectively communicate in client-server architecture with clients. The network-based marketplace 12 provides server-side functionality, via the network 14 (e.g., the Internet), to the one or more client machines 20 and 22. Similarly, the network-based social platform 13 provides server-side functionality, via the network 14 (e.g., the Internet), to the one or more client machines 20 and 22. FIG. 1 illustrates, for example, a web client 16 (e.g., a browser, such as the Internet Explorer browser developed by Microsoft Corporation of Redmond, Wash. State), and a programmatic client 18 executing on respective client machines 20 and 22.

Turning specifically to the network-based social platform 13, an application program interface (API) server 25 and a web server 27 are coupled to, and provide programmatic and web interfaces respectively to, one or more application servers 29. The application servers 29 may host one or more social applications 31 and a network-based marketplace interface module 33 that communicates with a communication module 39 and a processing module 41. The application servers 29 are, in turn, shown to be coupled to one or more database server(s) 35 that facilitate access to one or more database(s) 37.

The social applications 31 provide a number of social networking functions and services to users that access the network-based social platform 13. For example, the social applications 31 may enable a user to store information in a profile that may be viewed at the client machines 20, 22 and to selectively grant access to information that appears on the profile to other users who may also view the profile at their client machines 20, 22. The social applications 31 may provide criteria that may be employed by a user to grant various levels of access to various levels of users. For example, a first user may access profile information associated with a second user responsive to the first user achieving the status of “friend” in relation to a second user. A user may achieve the status of friend by accepting an invitation from another user or by sending a request to a user that subsequently grants the request.

The social applications 31 may further enable third-party service providers to add “applications” on the network-based social platform 13 that are utilized by users to interact with other users. For example, a network-based marketplace application may be added by a third-party service provider in the form of the network-based marketplace interface module 33, the communication module 39, and the processing module 41 that may provide market application services in the network-based social platform 13 environment and may communicate with the network-based marketplace 12.

In one embodiment, a request related to the marketplace application may be generally processed as follows. The request may originate at the client machines 20, 22 that communicate the request via programmatic or web interface services 25, 27 to the social applications 31 that, in turn, communicate the request to the network-based marketplace interface module 33 that, in turn, communicates the request to the communication module 39 and processing module 41 that process the request. Conversely, the communication module 39 and processing module 41 may respond to the social applications 31 via the network-based marketplace interface module 33. In some instances processing of the request may require communication with the network-based marketplace 12. In such instances the communication module 39 or the processing module 41 may communicate via the API server 25 with the network-based marketplace 12.

The network-based social platform 13 may be embodied as Facebook services, a social utility that connects people with friends and others who work, study and live around them provided by Facebook of Palo Alto, Calif. Another embodiment for the network-based social platform may be TWITTER® services, which is also a social utility, provided by Twitter of San Francisco, Calif.

The web client 16, it will be appreciated, in one embodiment accesses the various social applications 31 via the web interface supported by the web server 27. Similarly, the programmatic client 18 in one embodiment accesses the various services and functions provided by the social applications 31 via the programmatic interface provided by the API server 25.

Turning to the network-based marketplace 12, an application program interface (API) server 24 and a web server 26 are coupled to, and provide programmatic and web interfaces respectively to, one or more application servers 28. The application servers 28 host one or more marketplace applications 30 and payment applications 32. The application servers 28 are, in turn, shown to be coupled to one or more database server(s) 35 that facilitate access to one or more databases 36.

The marketplace applications 30 provide a number of marketplace functions and services to users that access the network-based marketplace 12. The payment applications 32 likewise provide a number of payment services and functions to users. The payment applications 32 may allow users to quantify for, and accumulate, value (e.g., in a commercial currency, such as the U.S. dollar, or a proprietary currency, such as “points”) in accounts, and then later to redeem the accumulated value for products (e.g., goods or services) that are made available via the marketplace applications 30. While the marketplace and payment applications 30 and 32, respectively, are shown in FIG. 1 to both form part of the network-based marketplace 12, it will be appreciated that, in alternative embodiments of the present disclosure, the payment applications 32 may form part of a payment service that is separate and distinct from the network-based marketplace 12. The network-based marketplace 12 may be embodied as eBay®, the world's online marketplace, provided by eBay of San Jose, Calif.

Further, while the system 100 shown in FIG. 1 employs a client-server architecture and a peer-to-peer architecture, the present disclosure is of course not limited to such an architecture, and could equally well find application in any combination of client-server, distributed, or peer-to-peer, architecture systems. The various marketplace and payment applications 30 and 32 could also be implemented as standalone software programs, which do not necessarily have networking capabilities.

The web client 16, it will be appreciated, accesses the various marketplace and payment applications 30 and 32 via the web interface supported by the web server 26. Similarly, the programmatic client 18 accesses the various services and functions provided by the marketplace and payment applications 30 and 32 via the programmatic interface provided by the API server 24. The programmatic client 18 may, for example, be a seller application (e.g., the TurboLister application developed by eBay Inc., of San Jose, Calif.) to enable sellers to author and manage listings of items on the network-based marketplace 12 in an off-line manner, and to perform batch-mode communications between the programmatic client 18 and the network-based marketplace 12.

It will be appreciated that the marketplace applications 30, payment applications 32, social applications 31, the network-based marketplace interface module 33, the communication module 39 and the processing module 41 may execute on a single platform. Accordingly, in one embodiment, the aforementioned applications/modules may execute on the network-based marketplace 12 and in another embodiment the aforementioned applications/module may execute on the network-based social platform 13.

FIG. 1 also illustrates a third-party application 38, executing on a third-party server machine 40, as having programmatic access to the network-based marketplace 12 via the programmatic interface provided by the API server 24. For example, the third-party application 38 may, utilizing information retrieved from the network-based marketplace 12, support one or more features or functions on a website hosted by the third party. The third-party website may, for example, provide one or more promotional, marketplace or payment functions that are supported by the relevant applications of the network-based marketplace 12.

### Social Platform Applications

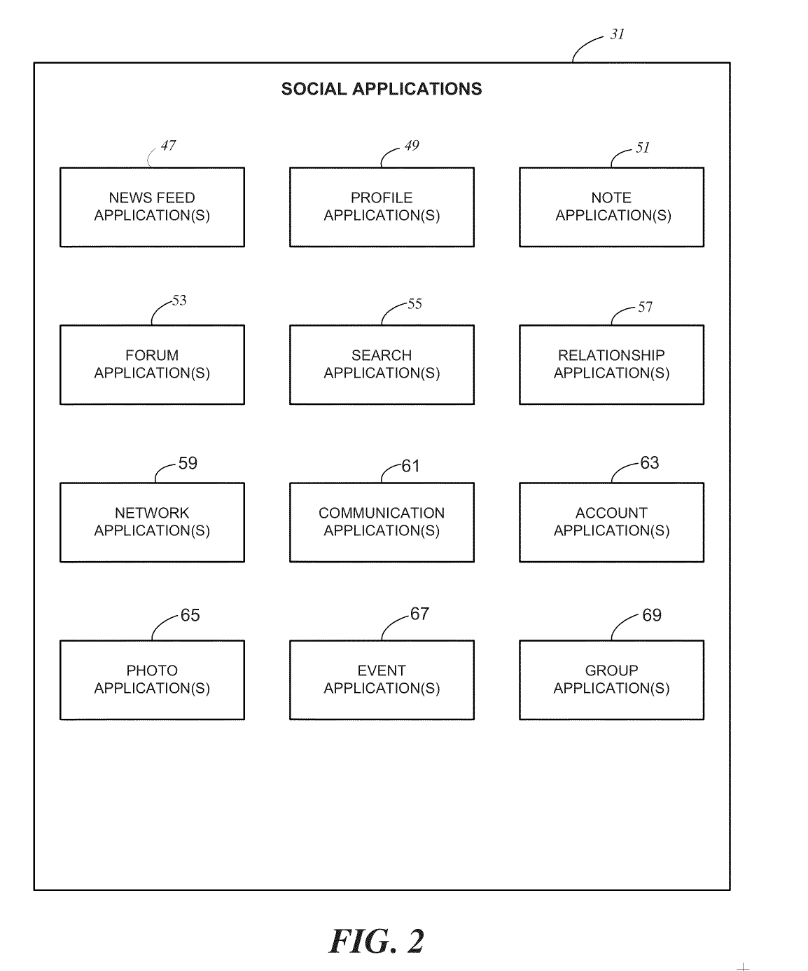

FIG. 2 is a block diagram illustrating applications that execute on the network-based social platform, according to an embodiment. The network-based social platform applications include news feed applications 47, profile applications 49, note applications 51, forum applications 53, search applications 55, relationship applications 57, network applications 59, communication applications 61, account applications 63, photo applications 65, event applications 67, and group applications 69.

The news feed applications 47 publish events associated with the user and friends of the user on the network-based social platform 13. The news feed applications 47 may publish the events on the user profile of a user. For example, the news feed applications 47 may publish the uploading of a photo album by one user on the user profile of the user and the user profiles of friends of the user.

The profile applications 49 may maintain user profiles for each of the users on the network-based social platform 13. Further, the profile applications 49 may enable a user to restrict access to selected parts of their profile to prevent viewing by other users. The note applications 51 may be used to author notes that may be published on various user interfaces.

The forum applications 53 may maintain a forum for users to post comments and display the forum via the profile associated with a user. The user may add comments to the forum, remove comments from the forum and restrict visibility to other users. In addition, other users may post comments to the forum.

The search applications 55 may enable a user to perform a keyword search for users, groups, and events. In addition, the search applications 55 may enable a user to search for content (e.g. favorite movies) on profiles accessible to the user.

The relationship applications 57 may maintain relationship information for the users. The network applications 59 may facilitate the addition of social networks by a user, the social networks based on a school, workplace, or region or any social construct for which the user may prove an affiliation. The communication applications 61 may process incoming and outgoing messages, maintain an inbox for each user, facilitate sharing of content, facilitate interaction among friends (e.g., poking), process requests, process events, process group invitations and process communicating notifications.

The account applications 63 may provide services to facilitate registering, updating, and deleting user accounts. The photo applications 65 may provide services to upload photographs, arrange photographs, set privacy options for albums and tag photographs with text strings. The event applications 67 may provide services to create events, review upcoming events, and review past events. The group applications 69 may be used to maintain group information, display group information, and navigate to groups.

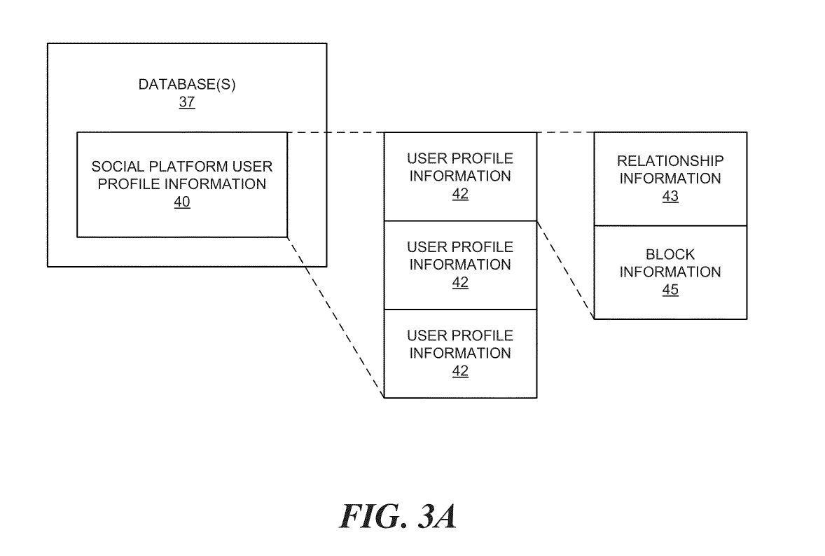

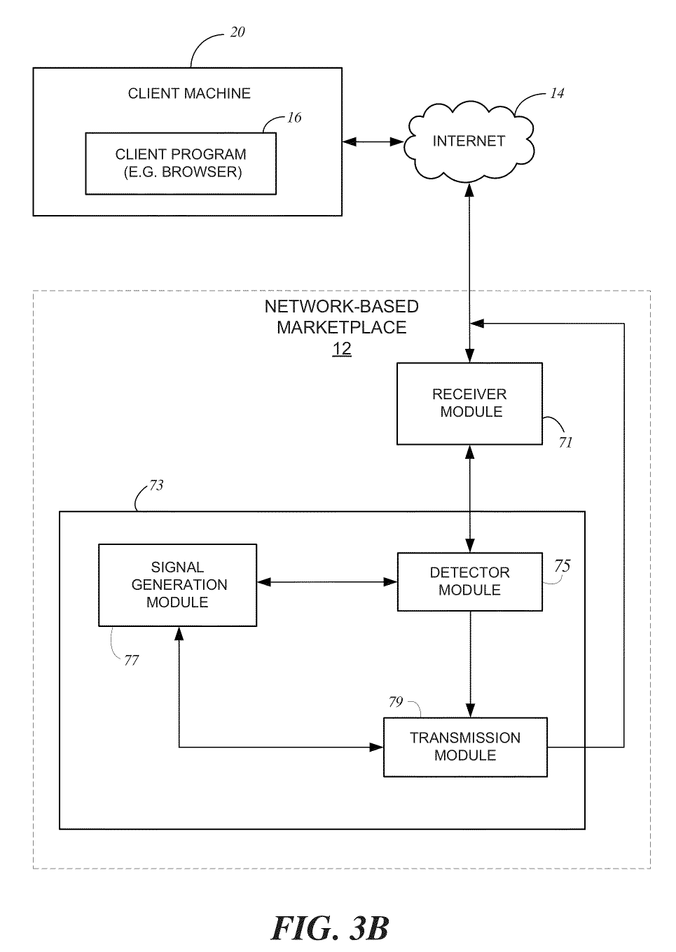

FIG. 3A is a block diagram illustrating a database 37, according to an embodiment, at the network-based social platform 13 of FIG. 1. The database 37 is shown to include social platform user profile information 40 that stores user profile information 42 for each user on the network-based social platform 13. The user profile information 42 may include information related to the user and specifically may include relationship information 43 and block information 45. The relationship information 43 may store a predetermined relationship between the user associated with the user profile information 42 and other users on the network-based social platform 13. For example, a first user may be designated a “friend,” or “favorite friend,” etc. with a second user, the first user associated with the user profile information 42 and the respective designations associated with increasing levels of disclosure between the first user and second user. The block information 45 may store a configured preference of the user to block the addition of an item by other users to the watch list associated with the user.

Turning to FIG. 3B, there is seen a system that may form part of the transaction network-based marketplace 12 of FIG. 1. The network-based marketplace 12 is shown in part in the drawing to make it clear that the system forms only a part of the network-based marketplace 12. The system includes a receiver module 71 for receiving signals from client machine 20, the signals identifying content to be transmitted to a social network server for storing at a message space of a user of the social network server. As used herein, “signals” could mean analog signals or digital signals such as web-based messages, including packet-based messages, or even a request message via an API call. Also included is analysis module 73. The analysis module 73 may include a detector module 75 responsive to signals received by the receiver module 71 for detecting the content, the identity of the social network, and the identity of the user of the social network. The analysis module 73 may also include a signal generation module 77 coupled to the detector module 75 responsive to signals detected by the detector module, such as, for example, signals identifying the content, the identity of the social network, and the identity of the user of the social network, for whom the content is intended, and other types of signals.

The signal generation module 77 may provide a rendering signal for rendering at least the content of the received signal. This rendering signal may be transmitted by transmission module 79 via network 14 to a social network, not shown. Alternatively, instead of transmitting signals via the network to a social network server, the transmission module 79 may transmit the signals, either via the network 14 or internally to the network-based marketplace 12, to a social platform integrated within a network-based marketplace 12. Further, the signals from signal generation module 77 may include signals such as signals requesting a user of the social network for an opinion about the content, or for chat, questions, or additional suggestions for items of content, among other things, as more fully discussed below. The foregoing may be termed “commentary” or “poll commentary” at various places herein. Such commentary may include one, or any combination of, the foregoing.

### Social Networking Platform Integration for a Publication System

A publication system user (the publication system sometimes being an ecommerce marketplace (for example, eBay®)), or a person accessing or browsing anywhere on the Internet, may share purchases or prospective purchases with friends on a social networking platform (e.g., Facebook.com or a platform integration within an ecommerce marketplace or other publication system). An electronic marketplace can be referred to as an ecommerce marketplace. These clothes, and other items similarly shared with friends as discussed herein, may be termed “commercial items,” or simply “items.” For example, within the ecommerce marketplace shopping flow, the user may be provided with the ability to post her transaction involving a commercial item to a social network wall. This wall concept is sometimes referred to herein as “storage space,” and could include renderable or viewable storage space. The user may tag a post with friends so that it shows up in their social graph(s). The post may include a picture and certain item information. Further, the friend may be provided with a user selectable “See Similar” function to see similar pictures and item information. For example, there is a “See Similar” function, such as “More Like This,” on eBay's fashion page. Typically the selection button for such function may be located adjacent to the item listing, or adjacent the item's photo, as a link. It could also be added as a contextual pop-up. The shared post may include a selection like “commentable” or “likeable.” These cases describe interactions that may feed into the social network, for example, Facebook. “Commentable” means that the marketplace user may share a particular product or item with his or her social graph via the Facebook Wall and include a comment along with it. “Likeable” means a Facebook user may provide a Facebook thumbs up if he or she likes the product or item. A social network user may also be able to provide a thumbs down if he or she doesn't like the product or item.

### Get an Opinion or Other Information Using a Social Platform

An ecommerce marketplace user may solicit the opinions of friends before buying an item on an ecommerce marketplace. To do this, the user may push an item to a social networking platform in the form of a poll. Other uses of social networks for shopping, or shopping information, may also be used.

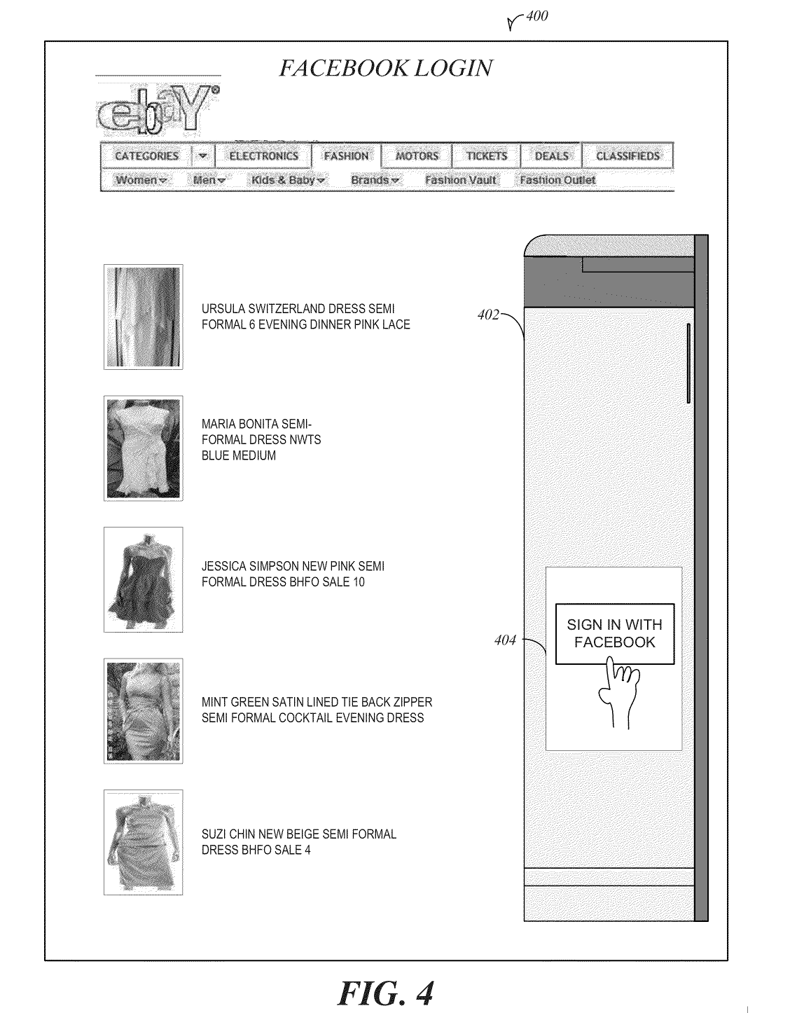

For example, an ecommerce marketplace user, used here as an example a party named Emily, may hear about the ability of eBay to work with social networks. Accordingly, she may log in to eBay, by a browser plug-in or otherwise, and navigate to the screen seen in FIG. 4. The screen may include a storage area 402 as well as an icon that enables her to sign in with the social network, Facebook in our example. The screen may also enable searching for items, in this example clothing.

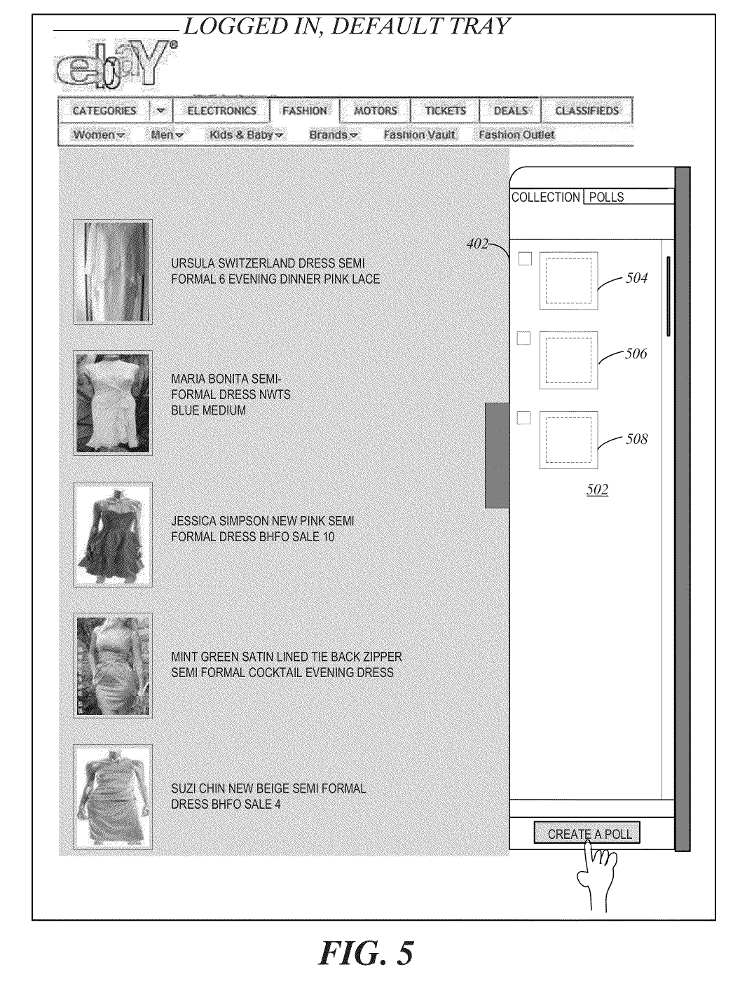

Moving on to FIG. 5, when Emily logs in, she sees as at least part of storage area 402 a storage area called a “Stash Tray” 502, with place holder storage areas 504, 506, 508, for items that she has seen on eBay. “Stash Tray” is used generically herein but the Stash Tray may be given any desired name such as, for example, “My Stash,” “My Stuff,” or other descriptive terms. Using well known drag and drop technology, or other technologies that allow moving content images and/or product information from one page to another page, or to other storage, the user, here Emily, may drag and drop, or otherwise place, images of products from ecommerce sites such as eBay, or from any web site on the Internet, onto a place holder storage area. The phrase “drag and drop” when used herein refers to any of the foregoing technologies. For example, she may drag and drop products such as clothing, an iPhone 4S, Nikon cameras and the like from the eBay site. She may use the products in the place holder storage areas 504, 506, 508, to create wish lists for future reference, if desired. She may also store these items in these storage areas to create a poll, she could also use tagging and ask friends what type of product is seen in a particular photograph and where that product can be purchased, among other requests. Alternatively, the place holders 504, 506, 508 may be pre-populated with products and categories suggested by the e-commerce site, eBay, based on the user's Facebook “Likes” using the social network technology discussed above. Additional such technology is disclosed in U.S. patent application Ser. No. 11/238,310 entitled “Method and System to Provide User Created Social Networks in a Distributed Commerce System,” filed Sep. 29, 2005, and Ser. No. 11/963,399 entitled “Sharing Shopping Information on a Network-Based Social Platform,” filed Dec. 21, 2007, both of which are assigned to the assignee of the present application, and both of which are incorporated herein by reference in their entirety.

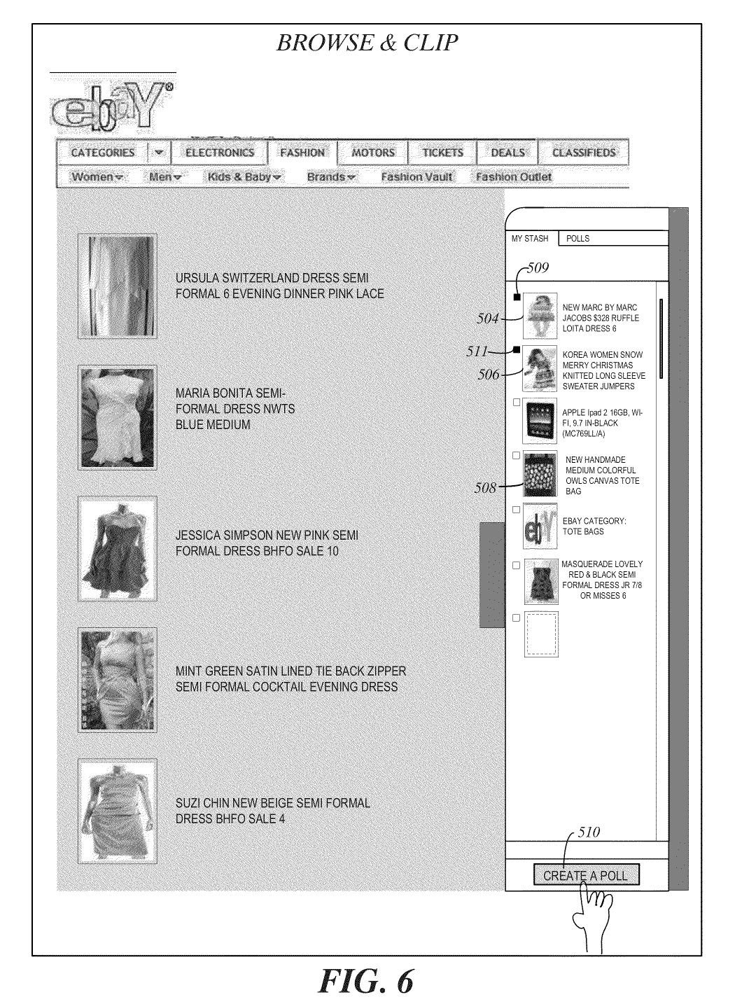

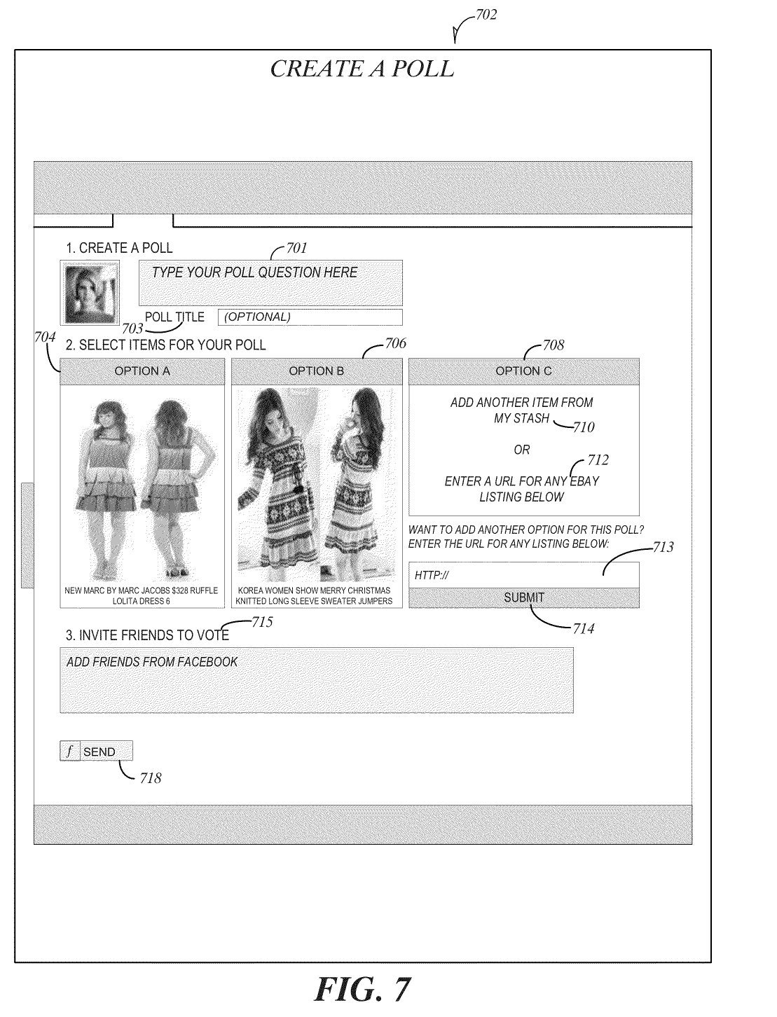

Continuing, while shopping on an e-commerce site such as eBay, Emily may drag and drop items (i.e. images of products) to place holder storage areas of her Stash Tray so she can revisit them later. As an example, Emily may have previously stored the two dresses, which she might like to wear to a wedding, in the place holders of the Stash Tray. She may select them as at 509, 511 of FIG. 6, and then, as an organizer, create a poll to ask her friends for advice, such as which dress would look better on her. She starts the poll by selecting “Create a Poll” 510 in FIG. 6, which may then activate technology within the ecommerce system to enable polling. Enabling the polling may be implemented by a polling signal from the publication system. Upon Emily selecting Create a Poll, the Stash Tray 702 may automatically expand to an extended, or perhaps the maximum, view, as illustrated in FIG. 7, and Emily may begin to enter poll details. For example Emily may see a place 701 to enter her poll question and, optionally, area 703 to enter a poll title. The two options, Option A, 704, and Option B, 706, present images of the two dresses she has selected, these images having been transmitted from the ecommerce cite in responses to the selection of “Create a Poll.” In addition there may be another place holder area 708 for Option C wherein another item may be added. The item may be from Emily's Stash Tray at 710, or from a URL that may be added for this purpose as at 713, as suggested at 712, or from other sources discussed below. Emily may, if she chooses, review the items she has selected and add another dress or other item at Option C, again by drag and drop or, for example, by using the URL feature illustrated at 713.

Also on FIG. 7 is an area 715 that may allow the user to invite friends to vote on the poll that is being set up. Other invitations may be to communicate, such as by chat, or to tag an item from the Internet or otherwise. This may be done by e-mail or by any other appropriate communication such as the technology discussed above.

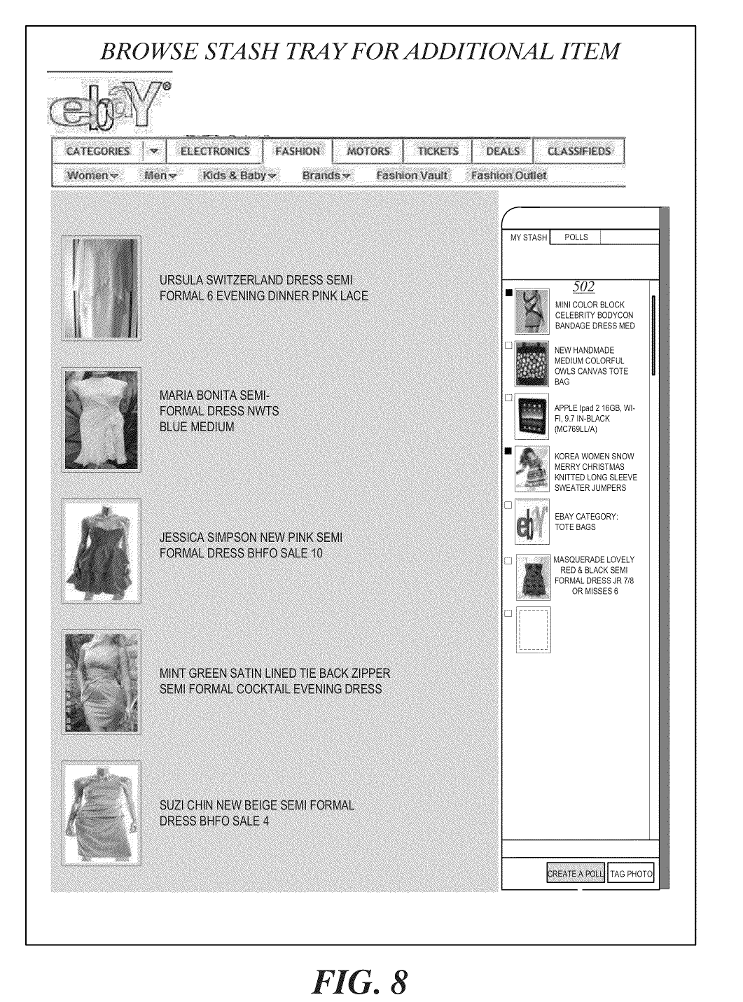

Turning to FIG. 8, the user may go back to her original Stash Tray 502 and determine whether there are any other items in her Stash Tray that she would like to add, for example, as Option C 708 on FIG. 7.

Assuming, for example, that Emily does not see any items on her Stash Tray 502, or elsewhere, that she would like to add as Option C, she may then select the user interface element “Send” 718 on FIG. 7 to invite friends on Facebook or other social network sites, or on eBay, to participate in the poll. The ecommerce system technology may, responsive to this selection, provide for the requested communication such as chat, email, Like, poll, or other similar functions.

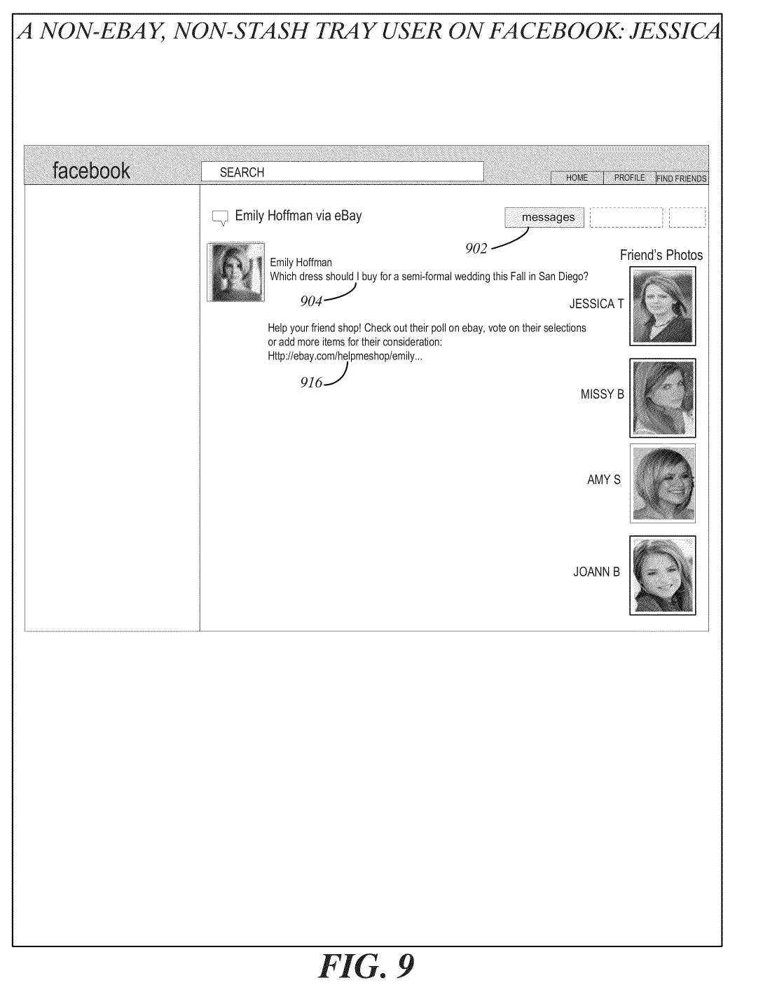

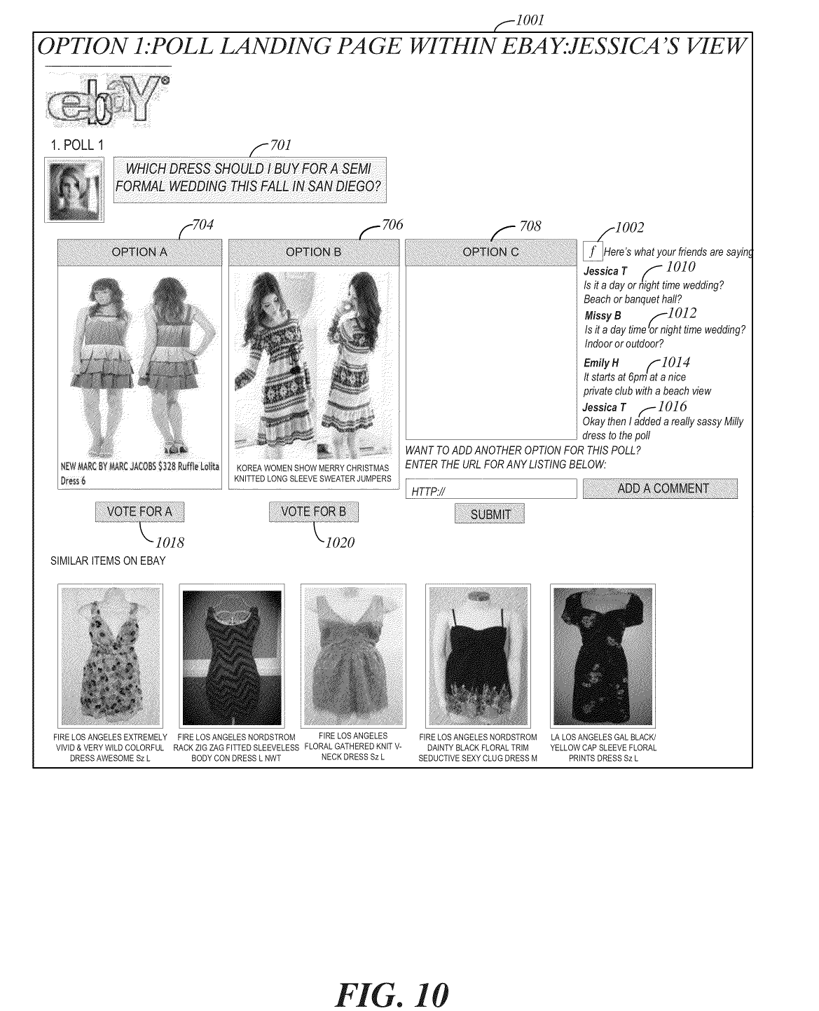

Jessica, as a participant, who may be a non-eBay user, and a non-Stash Tray user, receives a message about the poll from Emily, as an organizer, via eBay in Jessica's Facebook inbox as seen in FIG. 9. Jessica may click the messages link 902 to view the dresses Emily has selected. Upon selecting the messages link 902, Jessica may be taken to a landing page on eBay or, alternatively, on Facebook, that recognizes Jessica and displays the poll that Emily has created. This may be seen in FIG. 10.

FIG. 10 illustrates a landing page 1001, according to an embodiment, where Jessica may look over the items for which Emily has asked for feedback at Option A in 704 and Option B in 706. In order for Jessica to get additional information, she may chat with friends or send other communications, and may decide she knows of a better dress.

In order to get additional information Jessica may, by chatting or other communication, as at 1001, ask for information such as, whether the wedding is day or night, at the beach, at a banquet hall, and the like. This is seen at 1010. Other users such as other friends participating in the poll, herein also called “participants,” such as Missy D at 1012 may reply, as may Emily as at 1014 where she may provide answers such as “It starts at 6 p.m., at a nice private club, with a beach view.” Each of the parties may also ask additional questions as at 1012 to help them in their opinion.

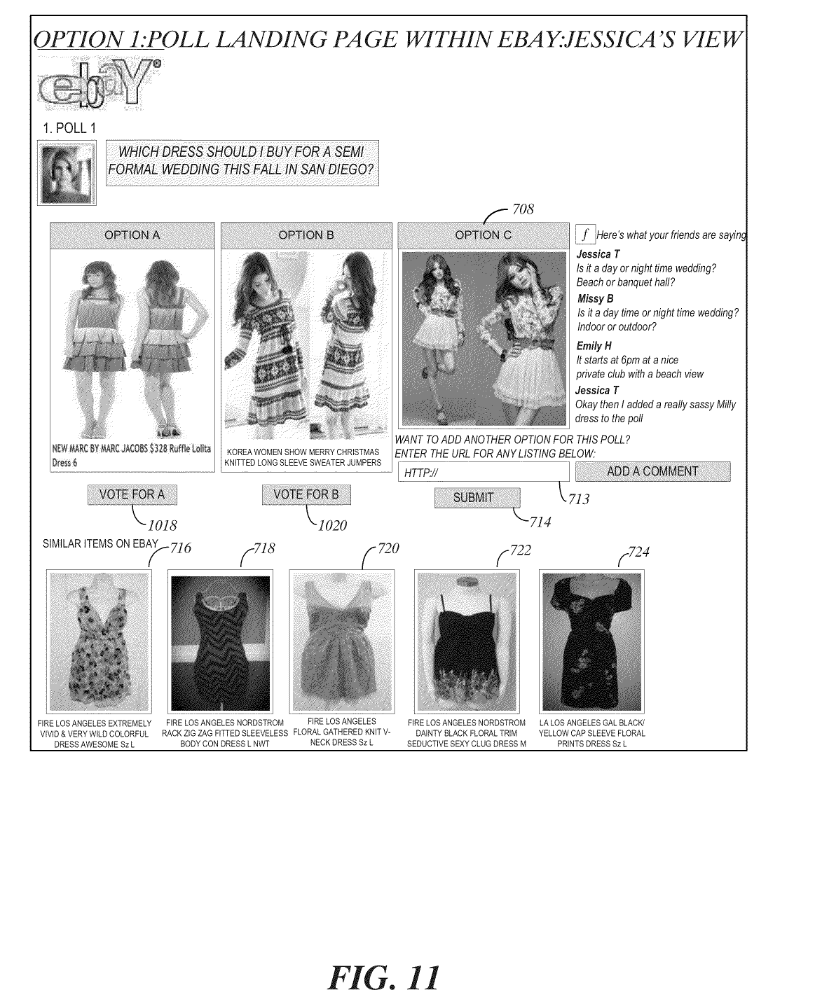

At 1016, Jessica may then add a Milly dress to the poll. This illustrates the fact that not only can the originator, here Emily, add items to the poll, but friends, here Jessica, can also add items for the poll. This may be seen in FIG. 11 where Jessica entered a new Milly dress to Option C at 708. This may be done by entering a URL at 713 or by drag and drop from a website or other storage, and by selecting “Submit.” as at 714.

With continued reference to FIG. 11, the e-commerce site, here eBay, may use the URL sent at 714, or another appropriate signal if a drag and drop were used instead of using a URL, as a trigger to execute a “See Similar” function to find similar items to the Milly dress represented by, for example, the URL at 713. Then, once again, using the technology discussed above for integrating information into a social network site, and perhaps also by executing a “See Similar” function, eBay may display images of similar items offered for sale on eBay, such as at 716 through 724 of FIG. 11.

In addition, the submit button 714, or some other selectable signal, may send the new poll, which includes the Milly dress of Option C at 708, to the other participants participating in the poll. The new poll sent to the other friends may include the similar items 716-724. At some appropriate time during the poll, each of the friends may vote using one of the voting buttons under the appropriate option. In addition to voting, the poll voters may themselves purchase any of the items in Option A through Option C or items 716-724 from eBay by selecting the item to enable the browser of the individual voter to present an appropriate web page from eBay to that individual.

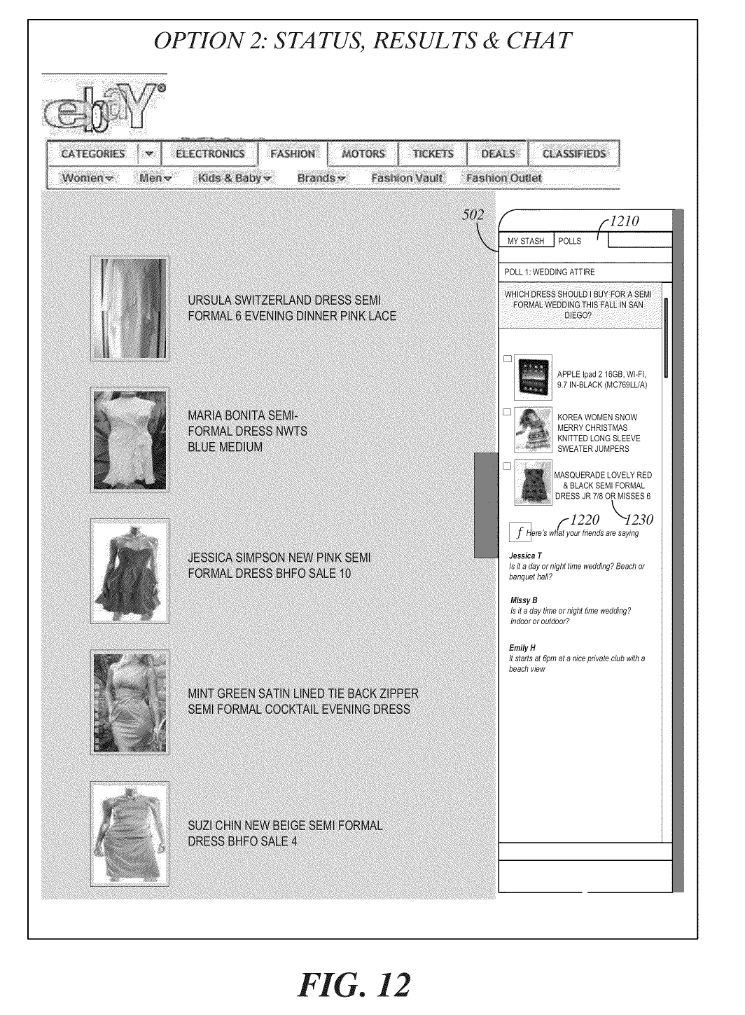

At an appropriate time, Emily may activate her Stash Tray 502, as seen in FIG. 12, and click the Polls tab 1210, which enables viewing of the polls by Emily, in order to read the notifications that her friends have voted, commented, or added a new item to her poll, and the results of the poll. She may also see the chat, as at 1220, between her friends that were invited to participate. She also sees at 1230 that her friend Jessica added a new dress at Option C, 708, of FIG. 11 and that seven of her friends voted for it.

The originator, here, Emily, may hover her curser over the winning dress at 1230 and a layer may appear that has the names of her friends and fellow eBay users who voted for it. This is an example of social influence. The poll may be published on eBay as well as on the social network such as Facebook so that all poll voters may take part in all aspects discussed above.

The originator, Emily, may decide to end the poll and buy the winning dress that participant Jessica suggested. This may be done, for example, by clicking on the item, here 1230, at which point Emily's browser may be presented with a landing page on eBay to view the item and purchase the dress. Further, Jessica, and other voters, may receive a notification on Facebook or other communication platforms that Emily has ended the poll. Jessica and other participants may be provided, through a link in her inbox, with a way to access the poll landing page of FIG. 12 to perform some or all of the foregoing options, as Emily did. Jessica, or other participants, being influenced by the identity of the participants who voted for the dress, may also purchase the dress.

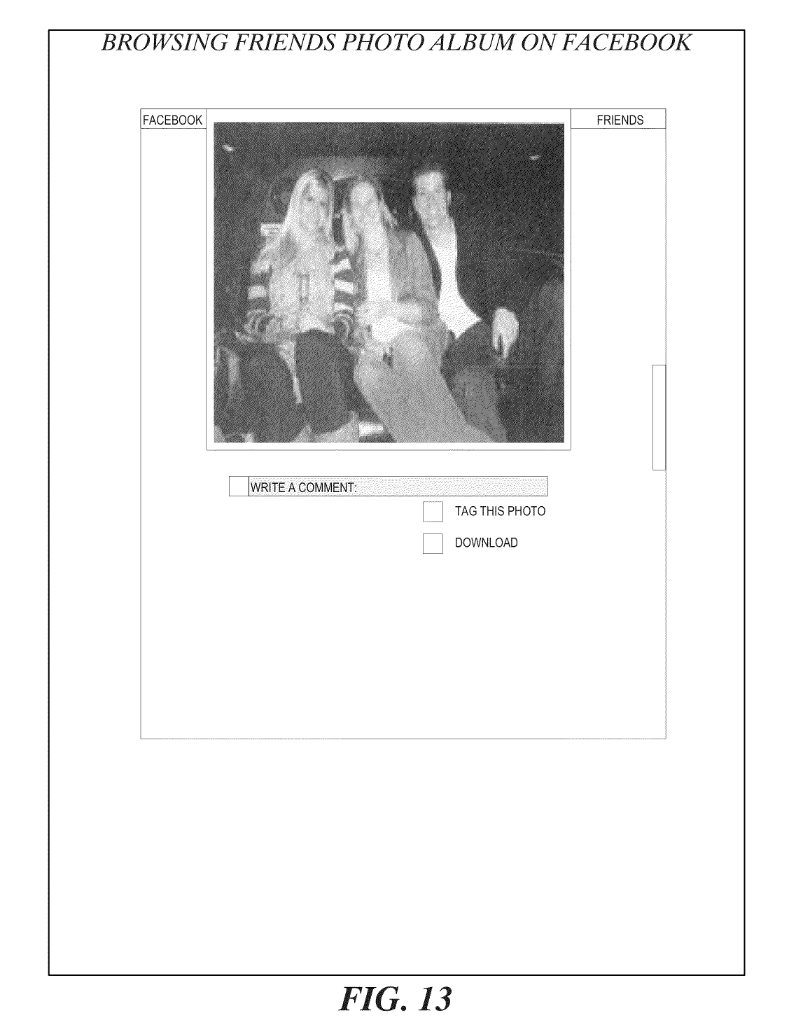

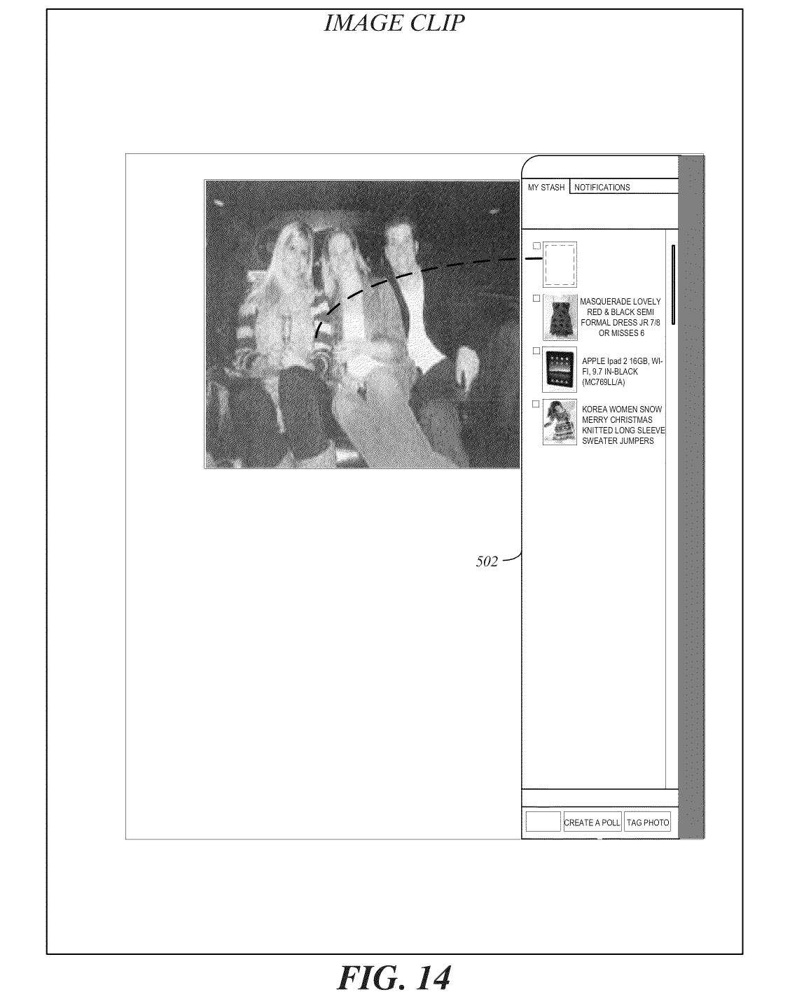

Turning now to FIG. 13, there is seen an image of a photograph that may be uploaded by a user or which may be uploaded by the originator, or snagged or otherwise taken from the Internet. The originator may open his or her Stash Tray 502 and drag and drop the image of the photograph into a place holder area such as 504 of Stash Tray 502, seen in FIG. 14.

As one example, the photograph may have been found on the Internet by browsing, and the originator may like the clothes or the accessories seen in the photograph. The originator might desire to learn the brand, size, and the like, and therefore puts the photograph into the Stash Tray of FIG. 14 as discussed above with respect to FIGS. 6 and 7, in order to obtain opinions on what a person in the photograph may be wearing, what is the bag she is carrying, and are there similar items for sale on an e-commerce site such as eBay. For example, the user may then create a poll, similar to the one described above with respect to FIG. 7, to ask the foregoing and similar questions regarding specific items in the photograph, by voting, chatting, or other appropriate communication.

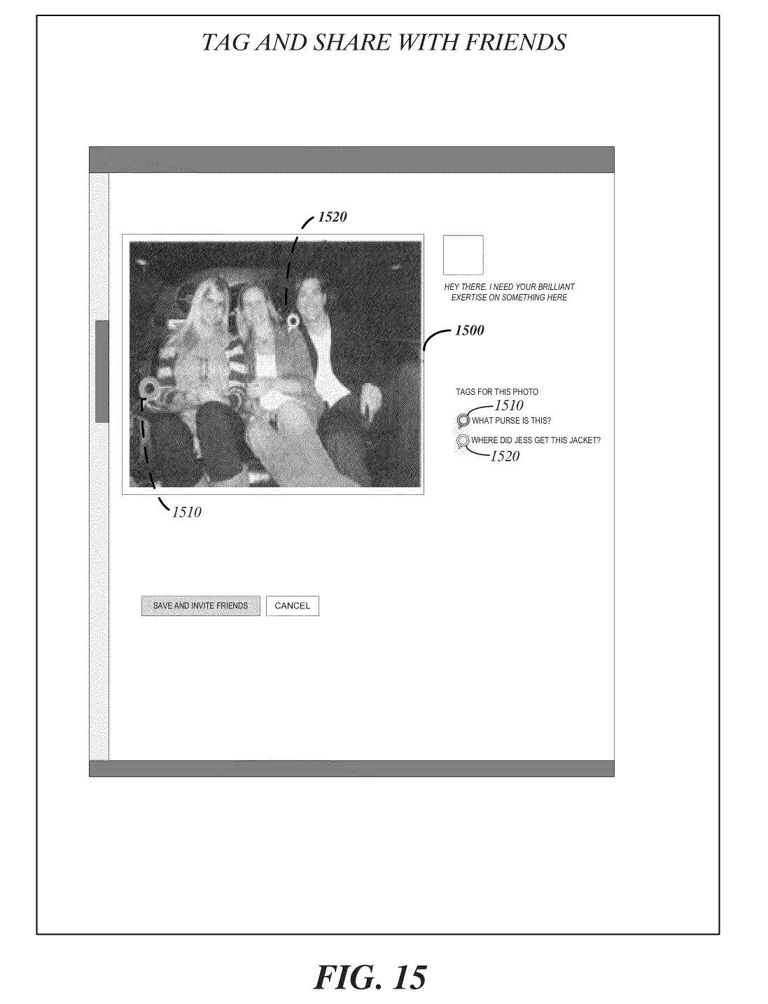

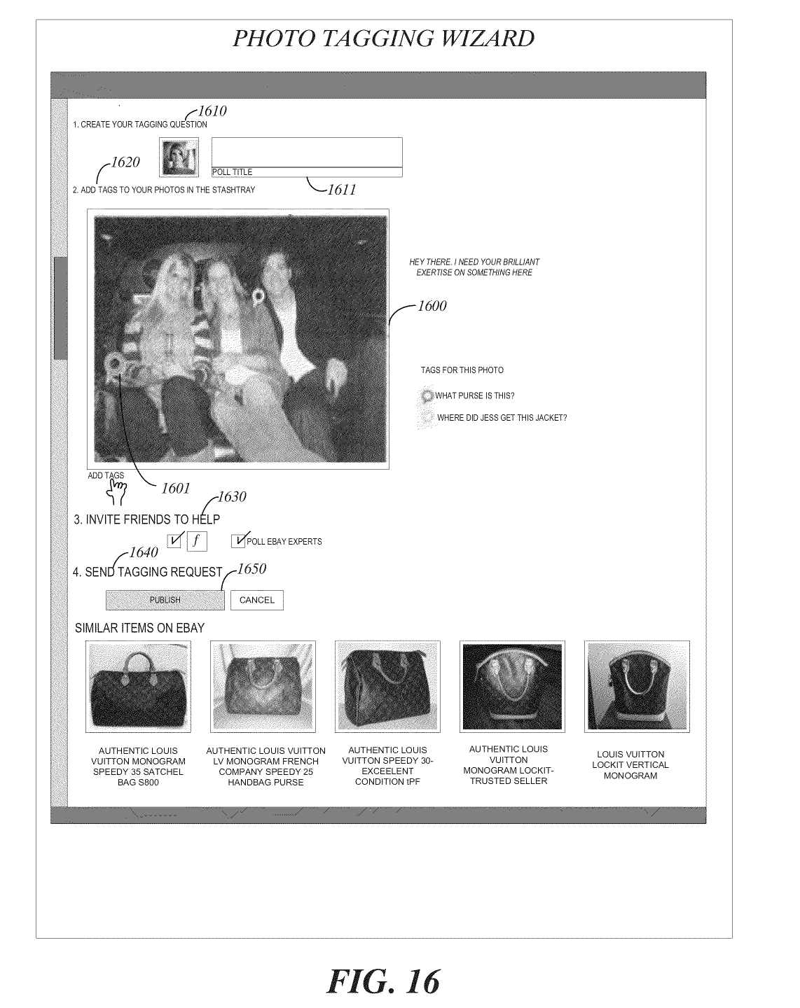

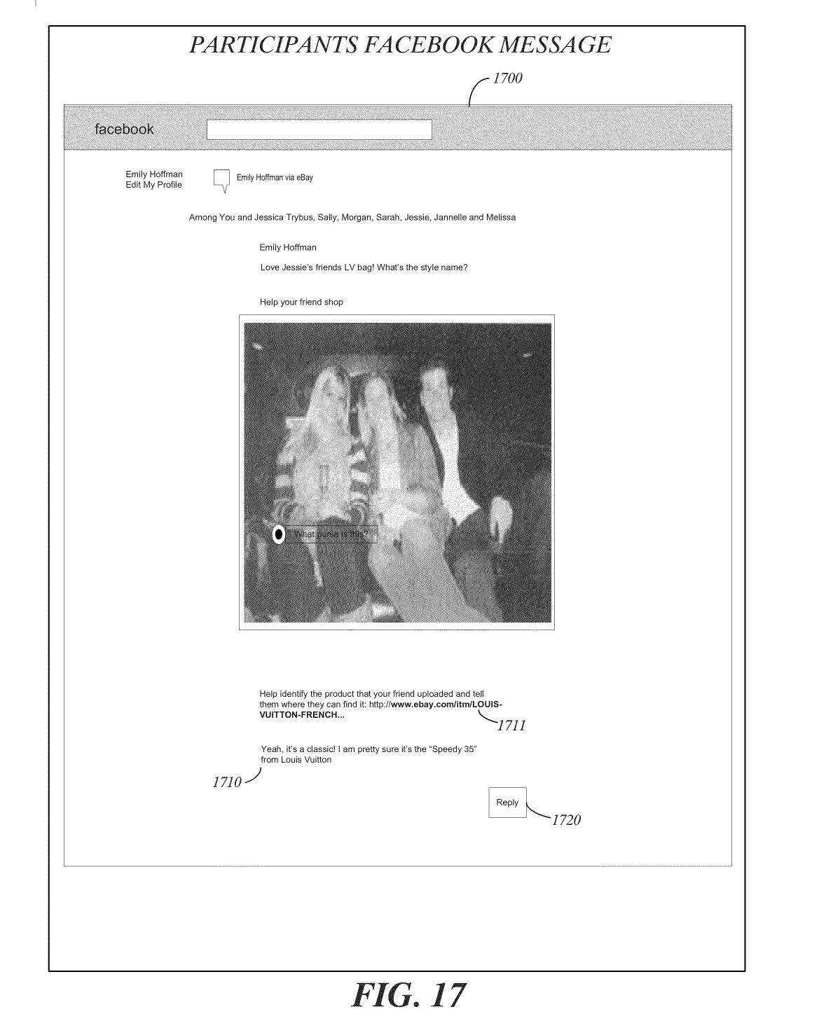

FIG. 15 illustrates a tagging example, according to an embodiment. Tagging was also alluded to with respect to FIG. 7, above. In FIG. 15, the user may tag various items in the photograph 1500, such as at 1510 and 1520, the tags asking the above questions with respect to the purse and/or sweater. That is, as noted under “Tags for this Photo,” tag 1510 asks “What purse is this?” Similarly, tag 1520 asks “Where did Jess get this jacket?” The answers may be supplied by friends as described above with respect to social network polling. Another example of tagging a photo may be seen in FIG. 16 where the questions are placed directly onto the photo 1600 as at 1601 that asks “What purse is this?” In either case this poll may utilize the various polling features discussed above. For example, a tagging question may be created as at 1610 and an optional title of the poll added as at 1611. The tags may be added to the photos in the Stash Tray as at 1620, in one embodiment. In another embodiment, with an operation flow similar to the foregoing, there may be a tab for “Activity” that designates the process of one or more operations, such as poll, chat, tagging, and the like. There may be another tab such as “My Stash” that may designate an area where products/items are stored for a polling operation. Likewise, there may be a tab for “Tagging” that designates an area where photos may be stored for the tagging process, much like the products/items are stored as discussed for the “My Stash” tab. Friends from a social network, who may or may not be eBay users, could be invited to help answer the questions as at 1630 by publishing to friends by selecting 1650. Referring to FIG. 17, participant friends may receive a participant's Facebook message page 1700, and reply as at 1710 with a response indicating, in this example, that the purse is a bag from Louis Vuitton, and perhaps indicating where the bag can be purchased, as at the URL page located at the URL placed at 1711. The participant may then select “Reply” as at 1720 and send the information as a reply to the originator as discussed below. Other opinions provided for the participants to render are operations such as voting up or down on a particular product, voting a “Like,” chatting, and similar opinions.

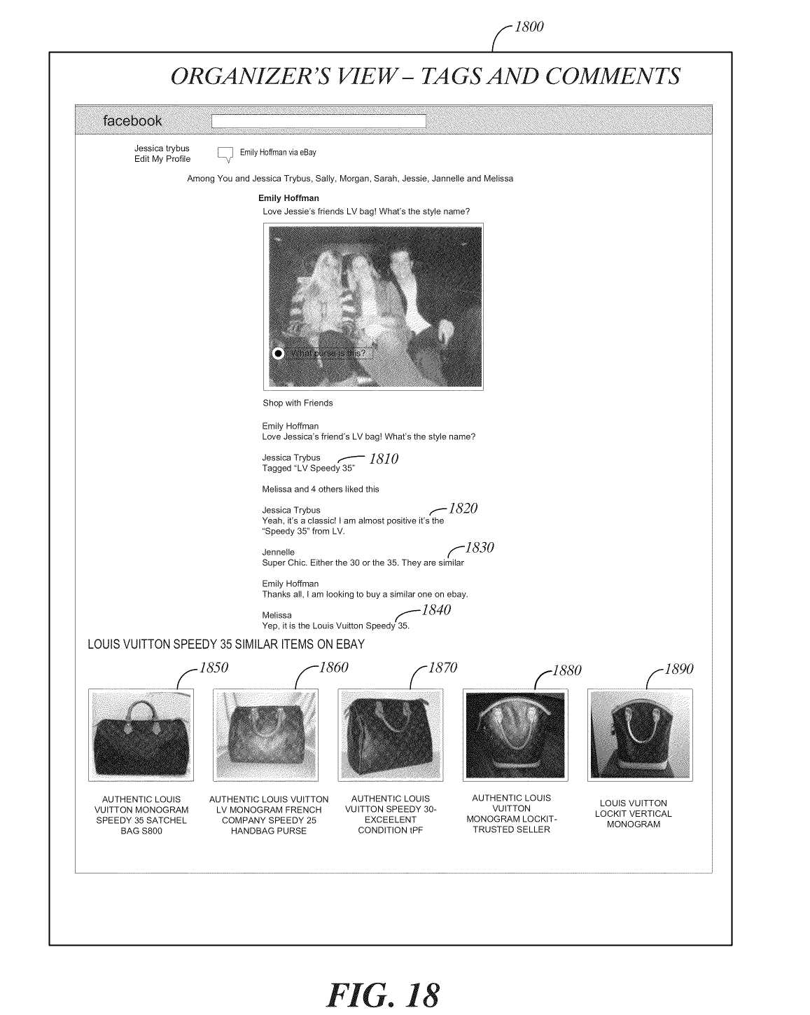

In another embodiment, the participant's Facebook message may be similar to that of FIG. 9 in which, instead of embedding a picture in the Facebook messages inbox, the user could click a URL and be taken to a landing page where they may respond to the tags. The tags and comments may be sent to the organizer, such as by page 1800 in FIG. 18, with tags and comments from participants such as Jessica, 1810, Jannelle, 1820 and Melissa, 1840. In one embodiment, the tags and comments page 1800 may also be sent to each participant. One of the participants, if desired, may have added a new item, may have requested a new poll for voting on the new item, or may have provided a URL where the original bag, or any such new item, can be purchased, as at 1711 of FIG. 17. Emily, using her view of the tags and comments from one or more of the participants on page 1800, may use the provided URL, or may use the chat/comment information 1810, 1820, 1830, 1840, to request a listing of the bag, or simply to request to purchase the bag. The eBay site, using the information of the request, may search and find various versions and colors of the bag represented by the URL or by the chat information, which may be used by the system to trigger such a request. The eBay system may also perform a “See Similar” or “More Like This” operation to determine similar bags and send images of them, along with the requested bag, to Emily. In FIG. 18, various versions and colors of the bag may be presented as at 1860-1890 so that the originator, Emily, may purchase any of the items. Images of similar bags may also be rendered. Similarly, in one embodiment, the various versions and color of the bag, and similar bags, can be sent to participants so that a participant, too, can purchase any of the bags. In an alternate embodiment, the organizer and the participants may be taken to a landing page, as discussed above with respect to FIG. 9 where the participants may tag and the organizer obtain information by coming and viewing the tags. A View Polls link such as 1210 on FIG. 12 may be included on the page 1800, for example, for the organizer to see the results of votes, tags, and the like, of the participants.

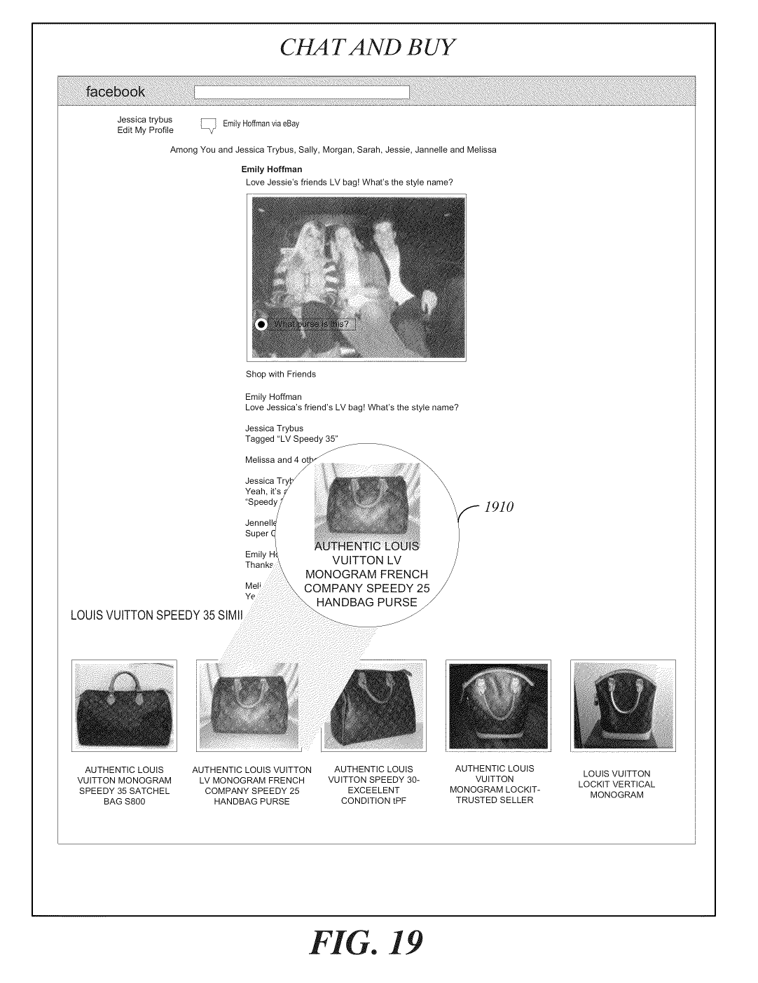

Referring to FIG. 19, the originator, Emily, may select the bag of her choice as at 1910. The bag may have been presented with an option to Buy it Now, which the originator may use to purchases the bag. Further, the bag may have been rendered with a “More Like This” which may be viewed as a type of “See similar” function to enable the originator herself to see similar items if desired. The participants may perform the similar functions on their view of FIG. 18.

The foregoing description illustrates a user of an ecommerce site, here the originator, as one example, shopping socially with people, such as the participants, who have a common interest with the user. The interest may be, as one example, shopping for fashion items on the eBay site. The participants may be friends on Facebook, or may be a following on Twitter. The user-originator may decide to shop with participants because the originator likes the styles suggested by the participants. The social shopping described may even be accomplished anonymously by creating polls, and the like, for groups who shop on Fashion pages on eBay. Opt-in for such anonymous shopping may be provided, and polls, chats, votes, and the like, can be communicated by email, chat, SMS, or other types of communication to participants who opt-in.

### Flow Charts

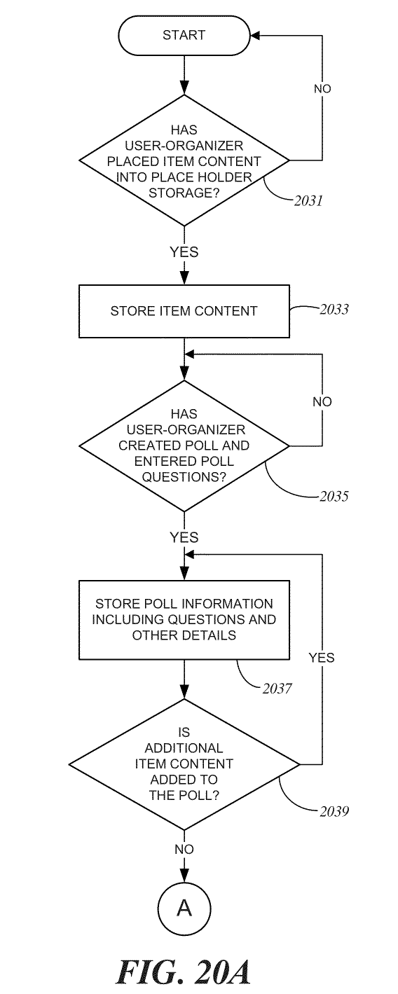

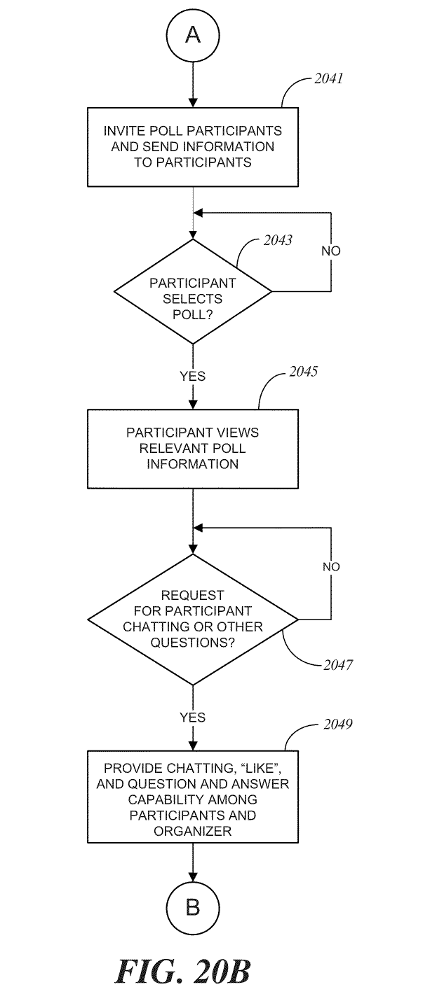

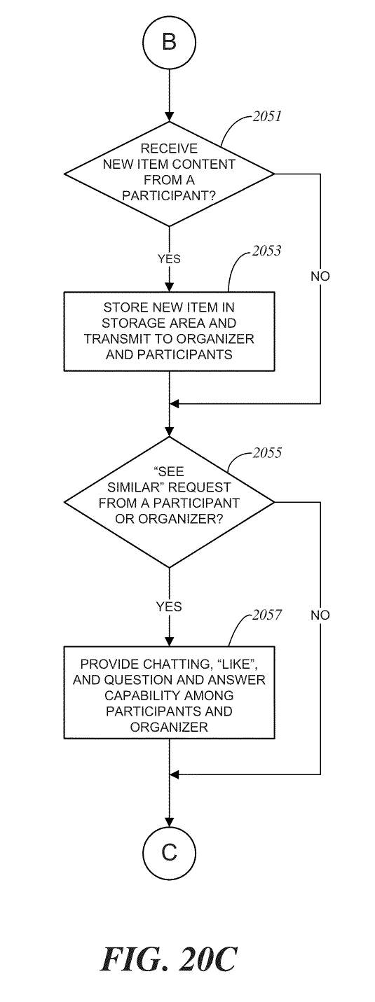

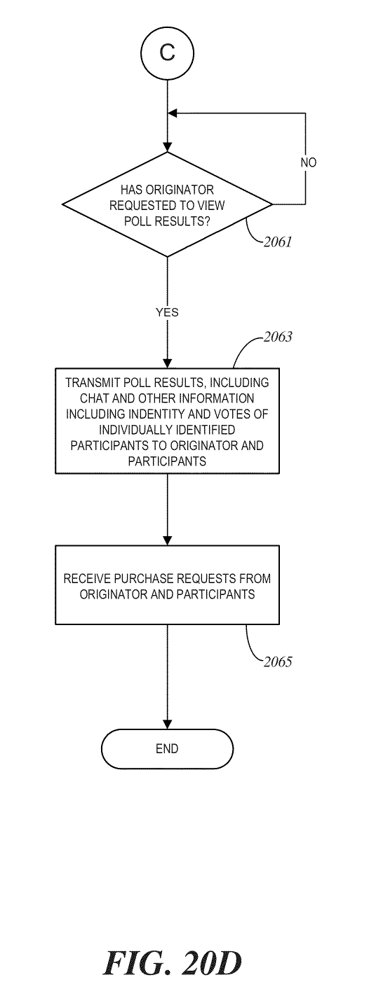

Flowcharts of example embodiments are seen in FIGS. 20A-20D, according to an embodiment.

At decision operation 2031 of FIG. 20A, the system may test to determine whether a user-organizer has placed item content into place holder storage such as 504, 506, 508 of FIG. 5, or as discussed with respect to FIG. 14. If the answer is “Yes,” the system may store the item content at operation 2033, such as at storage locations representing the place holder storage.

The system may, as at 2035, test to determine whether the user-organizer has created a poll with respect to the stored item content and entered poll questions as discussed with respect to FIGS. 7 and 14. If the answer is “Yes,” the system may store the poll information at 2037, including the identity of the poll participants selected by the originator, and other details discussed with respect to FIGS. 7 and 14. If additional content is added to the poll at 2039, as was previously discussed with respect to item 714 of FIG. 7, or as discussed generally with respect to FIG. 16, that content may also be stored as at 2037. If no further or additional item content is added to the poll at 2039, the operation proceeds to 2041 of FIG. 20B. At operation 2041 the system sends an invitation to poll participants to take part in the poll, and also sends the relevant poll information discussed at operation 2037.

If a participant at a client machine selects the poll in order to view it, as discussed with respect to FIG. 9, this may be detected by the system at 2043 and the participant may at operation 2045 see the relevant poll information sent by the system, as discussed with respect to FIGS. 10 and 17. If a participant who has selected the poll wishes to chat or otherwise discuss the items or other subjects relevant to the poll, the system may at 2047 detect a request by the participant to engage in chat or other questions. If such is detected, the system may, at 2049, provide or enable chat or discussion capability among the participants and the organizer, again as discussed above with respect to FIGS. 7 and 17. The participant may then look over the items the organizer has requested feedback about. If the participant selects another item to add to the items added by the organizer, the system may detect this at 2051 of FIG. 20C and provide for storage an image of the new item at 2053, for example as stored in the storage area similar to 708 of FIG. 11, and also as at FIG. 18, for rendering at participant and organizer client machines. A participant or the organizer may request the system to find similar items to those stored in the storage area(s) 704, and/or 706, and/or 708 of FIG. 7, and also as at FIG. 18. In this case the system may detect this request as at 2055 and find similar items, such as by using a function such as the “More Like This” function of eBay, and may send images of similar items to the participants and/or organizer. Alternatively, and without the foregoing request, the system may merely use the selection of the new item to trigger a “More Like This” type function in order to present the new items and similar items.

A new poll may also be created, if desired, which includes the new item added by the participant as discussed at operation 2051, above, and/or the items resulting from the “More Like This” type of search. The system may test for this new poll at a testing operation (now shown). Whether a new poll is created or not the system may transmit poll results, either the results of the original poll for the items from the originator, or the results of the new poll, if any, with the items from the originator and the new item(s) from the participant. These results may be transmitted as at 2063 as shown on FIG. 20D, for review by the originator and the participants. It will be appreciated by those of ordinary skill in the art that the poll results may be sent without the request as at 2061, as shown on FIG. 20D, or by request of a participant instead of, or as well as, the request of the originator. Any of the participants or the originator may, as at 2065, as shown on FIG. 20D, send the ecommerce system a request for purchase for any of the items presented in the poll, whether the original items of the originator, the new item of the participant, or a similar items from 2057, as shown on FIG. 20C.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It may be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

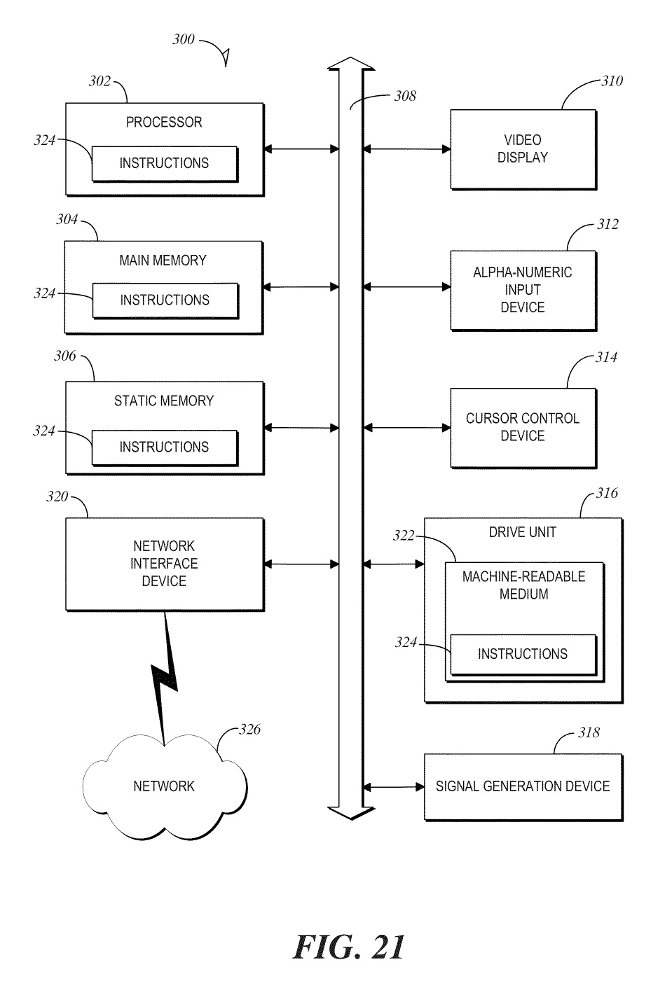

FIG. 21 is a block diagram of machine in the example form of a computer system 300 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processor 302 (e.g., a central processing unit (CPU), a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a user interface (UI) navigation device 314 (e.g., a mouse), a disk drive unit 316, a signal generation device 318 (e.g., a speaker) and a network interface device 320.

### Machine-Readable Medium

The disk drive unit 316 includes a machine-readable medium 322 on which is stored one or more sets of data structures and instructions 324 (e.g., software) embodying or utilized by any one or more of the methodologies or functions described herein. The instructions 324 may also reside, completely or at least partially, within the main memory 304, static memory 306, and/or within the processor 302 during execution thereof by the computer system 300, the main memory 304 and the processor 302 also constituting machine-readable media.

While the machine-readable medium 322 is shown in an example embodiment to be a single medium, the term “machine-readable medium” may include a single medium or multiple media (e.g., a centralized or distributed database, and/or associated caches and servers) that store the one or more instructions 324 or data structures. The term “machine-readable medium” shall also be taken to include any tangible medium that is capable of storing, encoding or carrying instructions for execution by the machine and that cause the machine to perform any one or more of the methodologies of the described implementations, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 324 may further be transmitted or received over a communications network 326 using a transmission medium. The instructions 324 may be transmitted using the network interface device 320 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
using a computer processor, receiving from a user of a publication system at least one first signal identifying first content and receiving a signal to create a poll for the first content, the poll comprising receiving poll commentary from participants within a social network;
responsive to receiving the at least one first signal, transmitting one or more signals representing the first content to a social network server for transmission to the participants;
responsive to receiving the signal to create a poll, transmitting to the social network server one or more signals requesting poll commentary from the participants;
receiving from the social network server additional content provided by a participant, the additional content to be used in the poll; and
receiving poll commentary from the social network server.

2. The method of claim 1 further comprising, subsequent to receiving the at least one first signal identifying first content, receiving from the user at least one second signal identifying second content and, responsive to receiving the at least one second signal, transmitting to the social server one or more signals requesting poll commentary from one or more participants for both the first content and the second content.

3. The method of claim 2 further comprising receiving from the social network server poll commentary for only the first content and the second content.

4. The method of claim 2 further comprising receiving from the network server poll commentary for the additional content and for at least one of the first content and the second content.

5. The method of claim 2 further comprising receiving from the social network server poll commentary for only the additional content.

6. The method of claim 2 wherein the publication system is an ecommerce system, the method further comprising receiving from one or more of the user and the participants a request to purchase a product included in at least one of the first content, the second content, and the additional content.

7. The method of claim 6 wherein each of the participants is identified, and the commentary of each commenting participant is associated with the identity of the commenting participant.

8. The method of claim 7 wherein the purchase is based on the commentary of an identified participant.

9. The method of claim 2 wherein the publication system is an ecommerce system, the method further comprising receiving from one or more of the user and the participants, a request for purchasing a product similar to a product included in at least one of the first content, the second content, and the additional content.

10. The method of claim 9 wherein each of the participants is identified, and the commentary of each commenting participant is associated with the identity of the commenting participant.

11. The method of claim 10 wherein the request for purchasing is based on the commentary of an identified participant.

12. The method of claim 2 further comprising transmitting signals representing at least one of the first content, the second content, and the additional content stored in an expandable tray, for rendering at a client machine.

13. Computer-readable storage having embedded therein a set of instructions which, when executed by one or more processors of a computer, causes the computer to execute the following operations:
receiving from a user of a publication system at least one first signal identifying first content and receiving a signal to create a poll for the first content, the poll comprising receiving poll commentary from participants within a social network;
responsive to receiving the at least one first signal, transmitting one or more signals representing the first content to a social network server for transmission to the participants;
responsive to receiving the signal to create a poll, transmitting to the social network server one or more signals requesting poll commentary from the participants;
receiving from the social network server additional content provided by a participant, the additional content to be used in the poll; and
receiving poll commentary from the social network server.

14. The computer storage of claim 13, the operations further comprising, subsequent to receiving the at least one first signal identifying first content, receiving from the user at least one second signal identifying second content and, responsive to receiving the at least one first second signal, transmitting to the social server one or more signals requesting poll commentary from one or more participants for both the first content and the second content.

15. The computer storage of claim 14 the operations further comprising receiving from the social network server poll commentary for only the first content and the second content.

16. The computer storage of claim 14 the operations further comprising receiving from the network server poll commentary for the additional content and for at least one of the first content and the second content.

17. The computer storage of claim 14 further comprising receiving from the social network server poll commentary for only the additional content.

18. The computer storage of claim 14 wherein the publication system is an ecommerce system, the operations further comprising receiving from one or more of the user and the participants a request to purchase at least one of the first content, the second content, and the additional content.

19. The computer storage of claim 18 wherein each of the participants is identified, and the commentary of each commenting participant is associated with the identity of the commenting participant.

20. The computer storage of claim 19 wherein the purchase is based on the commentary of an identified participant.

21. The computer storage of claim 14 wherein the publication system is an ecommerce system, the operations further comprising receiving from one or more of the user and the participants, a request for purchasing a product similar to a product included in at least one of the first content, the second content, and the additional content.

22. The computer storage of claim 21 wherein each of the participants is identified, and the commentary of each commenting participant is associated with the identity of the commenting participant.

23. The computer storage of claim 22 wherein the request for purchasing is based on the commentary of an identified participant.

24. The computer storage of claim 14 further comprising transmitting signals representing at least one of the first content, the second content, and the additional content stored in an expandable tray, for rendering at a client machine.

25. A system comprising:
one or more computer processors configured to store and execute:
a receiver module to receive from a user of a publication system at least one first signal that identifies first content, the receiver module to further receive a signal to create a poll for the first content, the poll comprises receipt of poll commentary from participants within a social network;
a signal transmission module, responsive to receipt the at least one first signal, to transmit one or more signals that represent the first content to a social network server for transmission to the participants; and
a poll signal creation module, responsive to receipt of the signal to create a poll, to transmit to the social network server one or more signals that request poll commentary from the participants;
the receiver module further to receive from the social network server additional content provided by a participant, the additional content to be used in the poll, and to receive poll commentary from the social network server.

26. The system of claim 25, the receiver module further, subsequent to receiving the at least one first signal identifying first content, receiving from the user at least one second signal identifying second content and, the signal transmission module further, responsive to receiving the at least one first second signal, transmitting to the social server one or more signals requesting poll commentary from one or more participants for both the first content and the second content.

27. The system of claim 25, the receiver module further receiving from the social network server poll commentary for only the first content and the second content.

28. The system of claim 25, the receiver module further receiving from the network server poll commentary for the additional content and at for least one of the first content and the second content.

29. The system of claim 25, the receiver module further receiving from the social network server poll commentary for only the additional content.

30. The system of claim 25 wherein the publication system is an ecommerce system, the receiver module further comprising receiving from one or more of the user and the participants a request to purchase a product included in at least one of the first content, the second content, and the additional content.
